(19) United States
(12) Patent Application Publication
(10) Pub. No.: US 2012/0276851 A1
(43) Pub. Date: Nov. 1, 2012

(54) SYSTEM FOR AUTO-IDENTIFICATION AND AUTO-ASSOCIATION OF AN AMUSEMENT DEVICE VIA A MOBILE DEVICE

(75) Inventors: William L. LAYNE, IV, Langhorne, PA (US); Ronald RICHARDS, Elmhurst, IL (US)

(73) Assignee: AMI ENTERTAINMENT NETWORK, INC., Bristol, PA (US)

(21) Appl. No.: 13/458,495

(22) Filed: Apr. 27, 2012

Related U.S. Application Data
(60) Provisional application No. 61/479,642, filed on Apr. 27, 2011.

(51) Int. Cl. H04B 7/00

(52) U.S. Cl. 455/41.2

(57) ABSTRACT

A system for automatically identifying and associating with an amusement device using a mobile device is provided. The system includes an amusement device connected to a network, a mobile device having a controller, and an application program stored within the mobile device. The amusement device has a display screen, a memory and a controller. The application program is configured to (i) automatically detect when the mobile device is within a predetermined geographic range of the amusement device, (ii) automatically issue an alert on the mobile device of the detected amusement device, and (iii) prompt the controller of the mobile device to automatically associate the mobile device with the detected amusement device.

### CROSS-REFERENCE TO RELATED APPLICATIONS

This application claims the benefit of U.S. Provisional Patent Application No. 61/479,642, filed on Apr. 27, 2011, entitled “System for Auto-Identification and Auto-Association of an Amusement Device Via a Mobile Device,” the entire contents of which are incorporated by reference herein.

### BACKGROUND OF THE INVENTION

An embodiment of the present invention relates generally to a mobile device, such as a smart device and, more particularly, to an application for a mobile smart device that can be downloaded to the mobile smart device and is configured to allow the mobile smart device to automatically identify and establish a connection with an amusement device.

Some amusement devices, such as game machines and jukeboxes, may be operated for free, while others, which are installed in bars, restaurants, airports, shopping malls, video arcades and the like, typically operate upon input of currency (i.e., coin, token, paper money, credit/debit cards and the like). For game machines, the game choices may include card games, sports games, games of skill, games of chance, action games, trivia games and the like. For jukeboxes, a plurality of songs are generally available for selection and play. Recently, jukeboxes have become computerized, capable of playing selections of music as MP3 files, streaming audio data sets, or the like.

Amusement devices are presently connected to networks and are generally equipped with wireless routers. The settings of the router, particularly the network name or service set identifier (SSID) and the wireless encryption protocol (WEP) key, the Wi-Fi Protected Access (WPA) key, the Wi-Fi Protected Access II (WPA2) key, or other similar security keys may also be programmed such that the router has a specific configuration that would be recognizable by another amusement device with knowledge of the router settings. For example, if a gaming machine is programmed to have knowledge of the configuration details of the router of a certain jukebox device, the gaming machine may be programmed to automatically detect, seek out and identify the recognizable router as part of an amusement device network. Thus, an automatic network connection may be established between the gaming machine and jukebox device. However, individual users of the gaming machine or jukebox device are not presently able to establish any type of automatic connection or other association with any of the devices.

It is desirable to create an application for a mobile smart device that can be downloaded directly to the mobile smart device, wherein the application allows the mobile smart device to automatically identify and establish an automatic association with an amusement device.

### BRIEF SUMMARY OF THE INVENTION

Briefly stated, an embodiment of the present invention relates to a system for automatically detecting and associating with an amusement device using a mobile device. The system comprises an amusement device connected to a network, a mobile device having a controller, and an application program within the mobile device. The amusement device has a display screen, a memory and a controller. The application program is configured to (i) automatically detect when the mobile device is within a predetermined geographic range of the amusement device, (ii) automatically issue an alert on the mobile device of the detected amusement device, and (iii) prompt the controller of the mobile device to automatically associate the mobile device with the detected amusement device.

Another preferred embodiment relates to a mobile device. The mobile device comprises a display, an input component, a controller and a memory for storing an application program. The application program is configured to (i) detect an amusement device which is connected to an amusement device network and which is within a predetermined geographic range of the mobile smart device, and (ii) prompt the controller to automatically associate the mobile smart device with the detected network amusement device.

Another preferred embodiment is directed to a method for automatically detecting and associating with an amusement device using a mobile device. The method comprises storing an application program in a mobile device, automatically detecting by the application program when the mobile device is within a predetermined geographic range of an amusement device connected to a network, automatically issuing an alert on the mobile device of the detected network amusement device, and automatically associating the mobile device with the detected network amusement device by the application program.

A further preferred embodiment is directed to a system for automatically detecting and associating with an amusement device using a mobile device. The system comprises an amusement device connected to a network; a mobile device which has a display, a memory and a controller; and an application program stored within the memory of the mobile device. The application program is configured to (i) retrieve global positioning system coordinates of the mobile device, (ii) prompt the controller of the mobile device to connect with a server of the network, (iii) detect at least one amusement device within a predetermined range of the global positioning system coordinates of the mobile device, (ii) issue an alert on the mobile device of the detected amusement device, and (iii) prompt the controller of the mobile device to automatically associate the mobile device with the identified amusement device.

Another preferred embodiment relates a system for automatically detecting and associating with an amusement device using a mobile device. The system comprises an amusement device connected to a network and having a display with an embedded quick response code; a mobile device having a display, a memory and a controller; and an application program stored within the memory of the mobile device. The mobile device is configured to scan the quick response code. The application program is configured to (i) interpret the scanned quick response code, (ii) verify if the amusement device is connected to the network, and (iii) prompt the controller to automatically associate the mobile device with the amusement device verified as being connected to the network.

### BRIEF DESCRIPTION OF THE DRAWINGS

The foregoing summary, as well as the following detailed description of preferred embodiments of the invention, will be better understood when read in conjunction with the appended drawings. For the purpose of illustration, there are shown in the drawings embodiments which are presently preferred. It should be understood, however, that the invention is not limited to the precise arrangements and instrumentalities shown.

FIG. 1A is a perspective view of an amusement device in accordance with a first preferred embodiment of the present invention;

FIG. 1B is a perspective view of an amusement device in accordance with a second preferred embodiment of the present invention;

FIG. 1C is a perspective view of an amusement device in accordance with a third preferred embodiment of the present invention;

FIG. 2 is a front perspective view of a mobile device in accordance with preferred embodiments of the present invention;

FIG. 3 is a schematic block diagram of a single mobile device scenario for the system according to the presently claimed invention; and

FIG. 4 is a schematic block diagram view of an amusement device network in accordance with preferred embodiments of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the apparatus and designated parts thereof. The terminology includes the above-listed words, derivatives thereof, and words of similar import. Additionally, the words “a” and “an”, as used in the claims and in the corresponding portions of the specification, mean “at least one.” Further, the terms “coin” or “currency” should not be construed as limiting and can be used herein to mean all forms of coin and paper currency from any country as well as proprietary tokens, game cards, credit cards, debit cards, chits, or other representative forms of credit and/or payment.

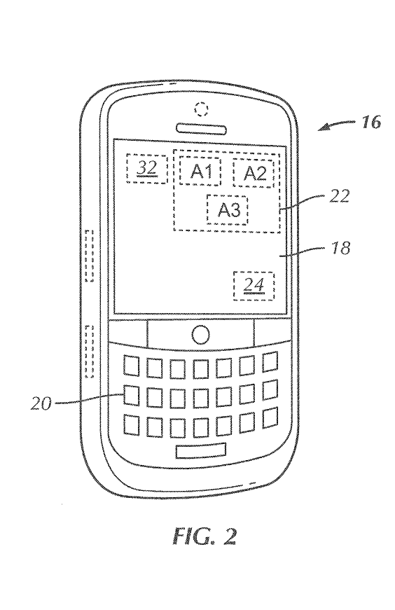

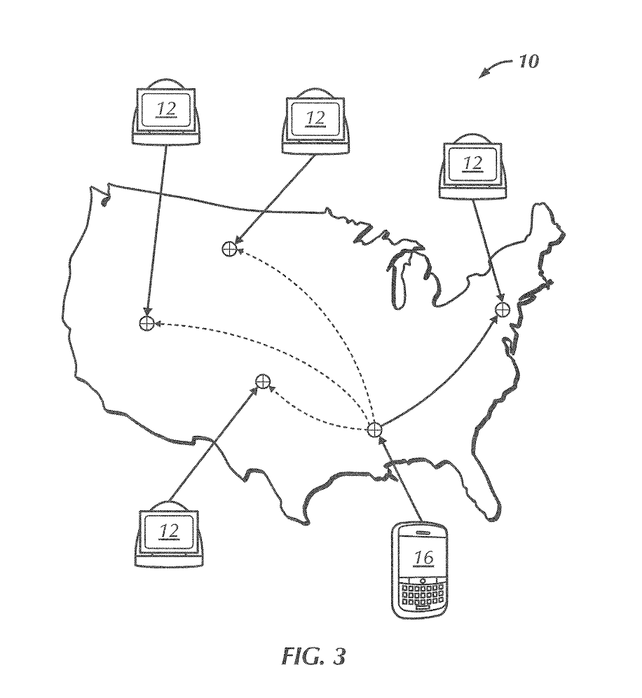

In the drawings, like numerals are used to indicate like elements throughout. Referring to the drawings in detail, FIG. 3 shows a preferred embodiment of an amusement device system 10 including an amusement device 12 and a mobile device 16. While FIG. 3 shows a single mobile device 16 and several amusement devices 12, it will be understood by those skilled in the art that the system 10 is designed so that many mobile devices 16 can simultaneously use the system 10. It will also be understood by those skilled in the art that while FIG. 2 show a mobile telephone device 16, the mobile device 16 may be any mobile device capable of connecting wirelessly to the internet, as discussed in more detail below.

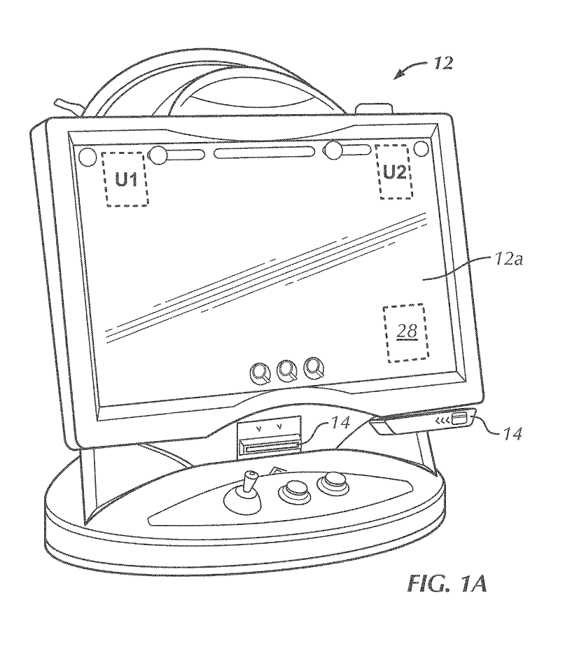

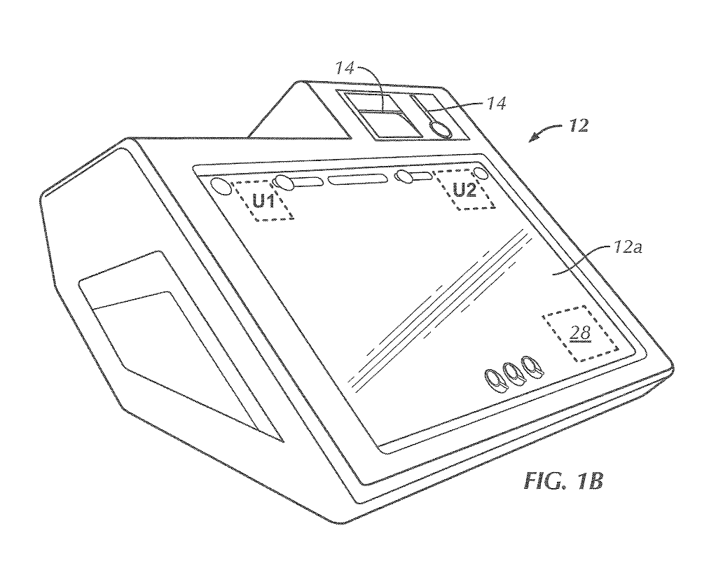

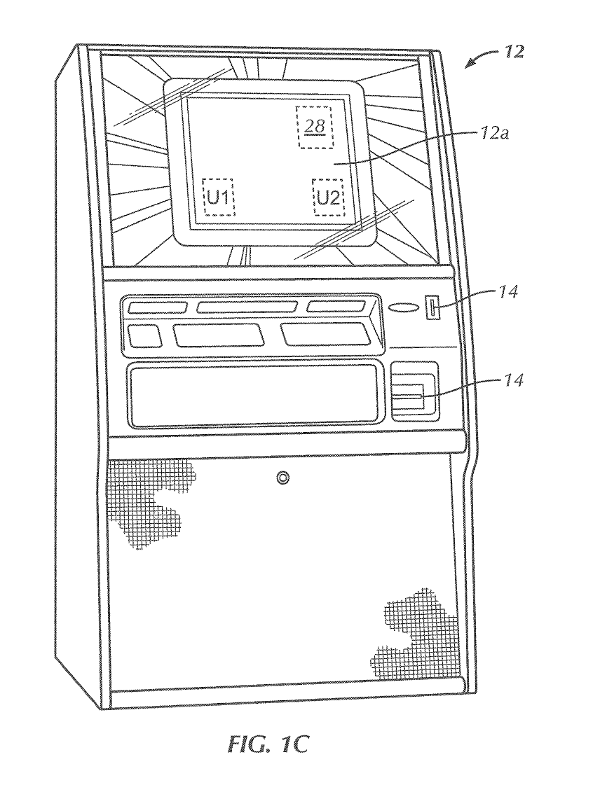

The system 10 includes a first amusement device 12 and, more preferably, a plurality of amusement devices 12. As is shown in FIGS. 1A-1C, each amusement device 12 includes a controller U1 and a memory U2. The memory U2 can be any known or suitable memory device such as random access memory (RAM), read only memory (ROM), flash RAM, hard disk, optical disk, or the like. The amusement device 12 further includes a video display 12a that is operatively connected to the controller U 1. Preferably, the display 12a is a touch input mechanism.

In the present embodiment, the amusement device 12 is a money-operated amusement device which includes at least one input component 14 that receives value in order to establish one or more playable credits. The value received may be at least one of currency, coins, tokens, chits, credits, credit cards/debit cards, or the like. Although only one input component 14 is shown, the amusement device 12 may include more than one input component 14 to give a user an option for payment, for permitting multiple players, or the like. Preferably, the amusement device 12 is made operable upon payment by a user, for example, by actuation of the input component 14. In other words, the user may not operate the amusement device 12 or select and play an electronic game or song until value is received at the input component 14 and/or one or more playable credits are issued to the user. However, free selections may be offered at the discretion of an operator of the amusement device 12. It will be understood by those skilled in the art that the amusement device 12 need not be a money-operated amusement device, but instead may be an amusement device which does not require a value to be input for operation of the amusement device.

The amusement devices 12 may be a free-standing or floor-standing apparatus (as shown in FIG. 1C), a table-top or counter-top apparatus (as shown in FIGS. 1A-1B), or a portable apparatus (not shown). The amusement devices 12 may be arranged in any configuration including table mount, wall mount, pole mount, portable, and the like without departing from the invention.

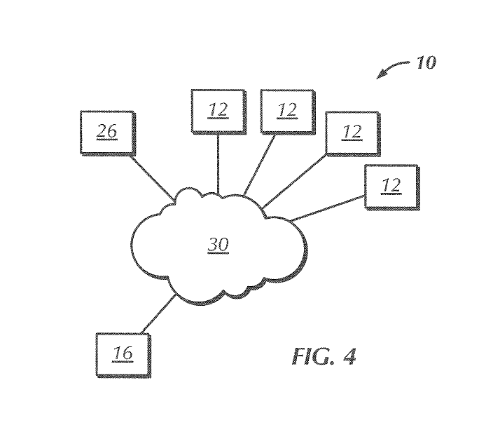

Each amusement device 12 is preferably part of a network 30 (see FIG. 4) having a plurality of additional amusement devices 12 connected thereto. Each of the amusement devices 12 is preferably in communication with a server 26. However, intermediate connections to the server 26, such as additional file servers, computers, other amusement devices 12, or the like, may also be implemented. Further, functions of the server 26 may be divided among a plurality of devices. The controller U1 of the amusement device 12 preferably communicates with the server 26 over an Ethernet port, a wireless transceiver, or the like and may communicate with other devices or file servers, access the Internet, communicate over wide area networks (WANs) or local area networks (LANs), or the like. Preferably, each amusement device 12 is equipped with a wireless router 28 (FIGS. 1A-1C) for wirelessly accessing the Internet and the amusement device network 30. The wireless router 28 is preferably configured with specific settings, including a SSID and WEP key, WPA key, WPAII key, or other similar security keys that identify the wireless router 28 as a router belonging to an amusement device 12 of the amusement device network 30. Each amusement device 12 also provides for remote or local access for service purposes.

The mobile device 16 may be any generally mobile device that is capable of connecting wirelessly to an electronic network, such as the internet, and preferably that is capable of functioning as a personal information manager. Examples of the mobile device 16 include an IPHONE, an IPAD, a PALM PILOT, a BLACKBERRY, a personal digital assistant (PDA) or any other smart device or the like. Referring to FIG. 2, the mobile device 16 is a mobile telephone device 16 preferably including a display screen or monitor 18 and optionally a keypad or keyboard 20. Preferably, the display screen 18 of mobile device 16 is a touchscreen. The mobile device 16 also preferably contains hardware that can support an internet or network connection using a wireless protocol, preferably one that is broadcast by the wireless router 28 of an amusement device 12 of the network 30.

A memory 22 (shown in phantom in FIG. 2) of the mobile device 16 is preferably capable of storing one or more applications or application programs downloaded preferably wirelessly from the internet. A controller 24 of the mobile device 16 is preferably configured to access and execute the one or more downloaded application programs from the memory 22. Preferably, the mobile device 16, and more particularly, the memory 22 of the mobile device 16, includes an application program A1 that enables the mobile device 16 to automatically sense or detect when the mobile device 16 is within a predetermined geographic range of the amusement device network 30 and, more particularly, within a predetermined range of an amusement device 12 connected to the amusement device network 30. This is possible because the application program A1 is equipped with all of the information (e.g., SSID, WEP key, WPA key, WPA2 key and other similar security keys) regarding the configuration details of a wireless router 28 which is necessary for connection to an amusement device 12 of the amusement device network 30 via the wireless router 28. More preferably, the application program A1 is equipped with a plurality of SSIDs and a plurality of security keys that correspond to the configuration details of a plurality of wireless routers, such that a connection may be established to any of the plurality of the amusement devices 12 of the amusement device network 30.

Specifically, once the application program A1 is downloaded to the mobile device 16, the mobile device 16 becomes equipped to identify and associate with each amusement device 12 of the amusement device network 30. According to one embodiment, the application program Al within the mobile device 16 automatically identifies or detects that the mobile device 16 is within the predetermined range of the amusement device network 30 and, more particularly, that there is an amusement device 12 of the amusement device network 30 within the predetermined geographic range.

Where the application program A1 is equipped with a set of SSIDs, the application program A1 may be automatically or manually triggered to try to connect to the identified amusement device 12 by using each the plurality of SSIDs, in succession, until it identifies the first SSID that matches the router settings for the identified amusement device 12. Similarly, the application program A1 may attempt to connect to the amusement device 12 by trying each of the security keys, in succession, until it identifies the first security key that matches the router settings for the identified amusement device 12. In another embodiment, the application program A1 may utilize the identified SSID and then look up the associated security key in an internal table which maintains the information for all of the known security keys. In the event that there are a plurality of amusement devices 12 detected as being within the predetermined geographic range, the application program A1 preferably attempts to connect to the identified amusement device 12 of the closest geographic proximity to the mobile device 16.

The application program A1 then automatically alerts the user of the mobile device 16 accordingly. This alert may take the form of, for example, a sound effect or vibration, display of a visual icon on the display screen 18, modification of an existing icon already present on the display screen 18, or display of a notification message on the display screen 18. However, it will be understood by those skilled in the art that the alert may take the form of any standard alert message mechanism. The application program A1 then automatically prompts the mobile device 16 to automatically establish a connection with the amusement device network 30 and, more specifically, automatically prompts the controller 24 of the mobile device 16 to automatically associate the mobile device 16 with the identified amusement device 12. Once the automatic association is established, the mobile device 16 can interact with the identified and associated amusement device 12. Thus, a user of a mobile device 16 equipped with the application A1 need not undertake any manual steps or activities to establish the beneficial automatic association with a geographically proximate amusement device 12.

According to another embodiment, the above identification/detection and association activities may only occur upon initiation of the application program A1 on the mobile device 16 by the user. However, after the user initiates the application program A1, the above-described identification and association activities are automatically implemented by the now active application program A1.

According to a further embodiment, an application program A2 may be downloaded to and stored in the memory 22 of the mobile device 16. Once downloaded and stored, the application program A2 may automatically seek out and retrieve the global positioning system (GPS) coordinates of the mobile device 16. The application program A2 will then either automatically connect with the server 26 or may only do so upon a specific command by the user. Connection with the server 26 will enable the application program A2 to identify any amusement devices 12 which are located in a facility, such as a bar, restaurant, and the like, having GPS coordinates within a predetermined range of the GPS coordinates of the mobile device 16. Once identification of any such devices 12 is completed, the application program A2 will alert the user accordingly.

For example, the application program A2 may preferably connect with the server 26 to identify any restaurants or bars equipped with an amusement device 12 and which have GPS coordinates within a predetermined distance, such as a few hundred feet, of the mobile device 16. The application program A2 will then alert the user with a message on the display 18 of the mobile device 16 informing the user of the closest locations of the amusement devices 12 and/or asking the user to confirm if he or she is at a particular identified location. The application program A2 may then, either automatically or upon a request by the user, initiate communication and association with the identified amusement device or devices 12 through the server 26, and all subsequent communication between the mobile device 16 and the amusement device or devices 12 will take place via the server 26. Alternatively, the application program A2 may initiate communication and association with the identified amusement device or devices 12 via the wireless router 28.

If an amusement device 12 is not identified within the predetermined range of the mobile device 16, but one or more amusement devices 12 are identified within a reasonable distance, preferably one half mile, of the mobile device 16, the application programs A1, A2 may communicate a message on the display 18 to the user of the mobile device 16 providing a list of the identified amusement devices 12 which are within a reasonable distance of the mobile device 16.

According to another embodiment, an application program A3 may enable the mobile device 16 and the amusement device 12 to be quickly and automatically associated with each other utilizing quick response (QR) code technology. According to this embodiment, the amusement device 12 is provided with a menu selection button or input button which, when selected or depressed, results in the controller U1 causing the display 12a of the amusement device 12 to show an embedded QR code. Once the application program A3 has been downloaded and stored in memory 22, the mobile device 16 user can scan or take a picture of the QR code using the mobile device 16, and the scanned QR code will be interpreted by the application program A3 for identification of the amusement device 12. Specifically, the application program A3 interprets the scanned QR code to determine if the amusement device 12 is a device within the amusement device network 30. If the amusement device 12 is identified to be within the amusement device network 30, the application program A3 automatically connects the mobile device 16 to the amusement device network 30 and establishes an automatic association between the mobile device 16 and the identified amusement device 12.

Once one or more of the application programs A1, A2, A3 have connected or associated the mobile device 16 with the amusement device network 30, and more particularly, with one or more amusement devices 12 of the amusement device network 30, the mobile device 16 is able to control the one or more associated amusement devices 12 to a limited extent. For example, in the context of jukeboxes, the mobile device 16 may be used to select and purchase a song stored on a jukebox device for playing of the selected song on the jukebox device with which the mobile device 16 is associated. In the context of gaming machines, the mobile device 16 may be used to select and purchase a game stored on a gaming machine for playing of the selected game on the gaming machine with which the mobile device 16 is associated. The mobile device 16 may also be used to purchase credits for a song or game stored on the associated amusement device 12, or the associated amusement device 12 may provide free credits to the user via the mobile device 16.

Referring to FIG. 2, the mobile device 16 may also be equipped with an accelerometer 32 which measures the orientation or vertical and horizontal positioning of the device 16. Upon download of one or more of the application programs A1, A2, A3, the mobile device 16 may utilize the accelerometer 32 to uniquely control the amusement device 12, and particularly to control navigation of a menu or a character or object on the display 12a of the amusement device 12. As an example of a character control mechanism, tilting, shaking or some other type of movement of the mobile device 16 may impact a displayed character, such as causing the character to move, jump, or attack another character. As an example of a game object control mechanism, the mobile device 16 may be used to control the paddle in a ping-pong or break out type game, or to control navigation of a plane, boat or other type of vehicle through a virtual world. In one embodiment, the mobile device 16 may serve as a virtual steering wheel for controlling vehicle navigation. In another embodiment, the mobile device 16 can be used to influence the virtual world of the game. For example, movement, such as tilting, of the mobile device 16 may cause the virtual game world to move or tilt in a direction similar to the mobile device 16. Such a tilting movement could also influence gravity in a sports game, such as basketball, golf or skee ball, to facilitate more effective shots or hits.

Additionally, in the context of gaming machines, the mobile device 16 equipped with one or more of the application programs A1, A2, A3 may be used as an input device for actively playing the selected game on the gaming machine. Specifically, the mobile device 16 may serve as a game controller for two or more players of the selected game. Alternatively, one player (i.e., the primary player) may play the selected game directly on the gaming machine, using the input device (e.g., touch input 12a) of the gaming machine, while other players (i.e., secondary players) may use their respective connected mobile devices 16 as input mechanisms to assist or play against the primary player. For example, the primary player may perform an action which causes coins or power-ups to appear on the display screen 18, and the secondary player can then control a game object to collect the displayed coins or power-ups for himself or for the primary player.

The mobile device 16 equipped with one or more of the application programs A1, A2, A3 can also serve as a private control or input interface for one of the players in a multiplayer game. For example, in a multiplayer trivia game, the user of a mobile device 16 which is connected with a gaming machine 12 may use the mobile device 16 to enter or input an answer to each trivia question, such that his or her entered answers are kept shielded from the view of the other players. The same principle and benefits apply in the context of a multiplayer card game, allowing the user of the connected mobile device 16 to keep the cards that he or she has been dealt shielded from the view of the other players.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A system for automatically detecting and associating with an amusement device using a mobile device, the system comprising:
an amusement device having a display screen, a memory and a first controller, the amusement device being connected to a network;
a mobile device having a second controller; and
an application program stored within the mobile device, the application program being configured to:
(i) automatically detect when the mobile device is within a predetermined geographic range of the amusement device,
(ii) automatically issue an alert on the mobile device of the detected amusement device, and
(iii) prompt the second controller of the mobile device to automatically associate the mobile device with the detected amusement device.

2. The system of claim 1, wherein the amusement device comprises a wireless router.

3. The system of claim 2, wherein the application program is equipped with settings information for the wireless router of the amusement device.

4. The system of claim 1, wherein the system comprises a plurality of amusement devices, the application program being configured to:
(i) automatically detect when the mobile device is within a predetermined geographic range of any of the plurality of amusement devices, and
(ii) prompt the second controller of the mobile device to automatically associate the mobile device with at least one of the detected amusement devices.

5. The system of claim 4, wherein each amusement device comprises a wireless router and the application program is equipped with settings information for the wireless router of each of the plurality of amusement devices.

6. The system of claim 1, wherein the amusement device is a jukebox which stores a plurality of songs, the mobile device being a tool for selecting and purchasing at least one song stored on the jukebox.

7. The system of claim 1, wherein the amusement device is a gaming machine which stores one or more games, the mobile device being a tool for selecting and purchasing a game stored on the gaming machine.

8. A mobile smart device comprising:
a display;
an input component;
a controller; and
a memory for storing an application program, the application program being configured to:
(i) detect an amusement device which is connected to an amusement device network and which is within a predetermined geographic range of the mobile smart device, and
(ii) prompt the controller of the mobile device to automatically associate the mobile smart device with the detected network amusement device.

9. The system of claim 8, wherein the mobile device comprises an accelerometer configured to measure at least one of the orientation, vertical positioning, or horizontal positioning of the mobile device.

10. The system of claim 9, wherein the mobile device is configured to be used as a tool for at least one of navigating a menu of the amusement device, controlling a character displayed on the amusement device, or controlling a game object displayed on the amusement device.

11. A method for automatically detecting and associating with an amusement device using a mobile device, the method comprising:
storing an application program within a mobile device,
automatically detecting by the application program when the mobile device is within a predetermined geographic range of an amusement device connected to a network, automatically issuing an alert on the mobile device of the detected network amusement device, and
automatically associating the mobile device with the detected network amusement device by the application program.

12. The method of claim 11, wherein the network comprises a plurality of amusement devices, each amusement device being equipped with a wireless router and the application program being equipped with settings information for the wireless router of each of the plurality of amusement devices.

13. The method of claim 12, wherein the step of automatically associating the mobile device with the detected amusement device by the application program comprises successively using each of the stored settings information by the application program until the settings information of the detected amusement device is encountered.

14. A system for automatically detecting and associating with an amusement device using a mobile device, the system comprising:
an amusement device connected to a network;
a mobile device having a display, a memory and a controller; and
an application program stored within the memory of the mobile device, the application program being configured to:
(i) retrieve global positioning system coordinates of the mobile device,
(ii) prompt the controller of the mobile device to connect with a server of the network,
(iii) detect at least one amusement device within a predetermined range of the global positioning system coordinates of the mobile device,
(ii) issue an alert on the mobile device of the detected amusement device, and
(iii) prompt the controller of the mobile device to automatically associate the mobile device with the identified amusement device.

15. A system for automatically detecting and associating with an amusement device using a mobile device, the system comprising:
an amusement device connected to a network and having a display with an embedded quick response code;
a mobile device having a display, a memory and a controller; and
an application program stored within the memory of the mobile device, the mobile device being configured to scan the quick response code, application program being configured to:
(i) interpret the scanned quick response code;
(ii) verify if the amusement device is connected to the network; and
(iii) prompt the controller of the mobile device to automatically associate the mobile device with the amusement device verified as being connected to the network.
